(19) United States
(12) Patent Application Publication
(10) Pub. No.: US 2026/0132004 A1
(43) Pub. Date: May 14, 2026

(54) APPARATUS FOR TEMPORARILY ALIGNING AND PROTECTING END SURFACE OF A POST FROM LIFTING DEVICE

(71) Applicant: David Franklin, Suffolk, VA (US)

(72) Inventor: David Franklin, Suffolk, VA (US)

(21) Appl. No.: 18/942,614

(22) Filed: Nov. 9, 2024

(51) Int. Cl. B66F 3/36

(52) U.S. Cl. CPC B66F 3/36

(57) ABSTRACT

An apparatus for temporarily aligning and protecting the end surface of a lifting post in way of a hydraulic bottle jack or similar typical lifting device in an adjacent relationship is disclosed. The apparatus includes a flat, rigid plate with an upper and lower surface. The plate provides protection by increasing surface area of the hard surface of the lifting device to a greater area on the softer, typically wooden post. The upper surface has a rim affixed to the edge and is sized to inset and reasonably center typical lifting post over the apparatus. The lower surface has a circular pipe affixed axially at its center and sized for insertion of a lifting device saddle. The pipe further includes numerous threaded holes on opposing ends to accommodate bolts, and the bolts can be turned as necessary to center a lifting device under the apparatus, and thus, the lifting post.

### TECHNICAL FIELD

The present disclosure relates generally to an apparatus for temporarily aligning and protecting the end surface of a post from a lifting device in a loaded, adjacent relationship.

### BACKGROUND

The action of lifting structures or equipment using the assistance of a hydraulic bottle jack or similar lifting device is typically accompanied by a post to accommodate the range of various heights. Some popular posts used in the construction and industrial trades are nominal square lumber (4″×4″, 6″×6″, etc.) found available at almost any home improvement store.

The typical characteristics of a bottle jack saddle (head) consists of a round plate of carbon steel 1″ to 2″ in diameter. In the trades, it is common to see a lumber post being held and simply resting on the jack saddle. While commonly satisfactory under light loading conditions, overloading using this method adds the danger of the jack saddle splitting the bottom of the post. This may result in equipment and property damage, as well as bodily harm or death.

For this reason, it is often necessary to add a piece of rigid metal under the post to discourage the bottom of the lumber from deforming or splitting. This can be very awkward when the operator is using one hand to stabilize the post while the other hand is pumping the jack. Often, the post is prone to move around on the jack saddle until some load is applied, thereby adding rigidity to the lifting assembly as a whole. Hereinafter, the term “lifting assembly” has been interchangeably used with the term “lifting device and associated lifting post”.

Further, not centering the post on the jack saddle leads to a moment being created. Often, when load is applied to a post that is not centered, it tips the jack and buckles the lifting assembly. Along with the difficulty of preventing post damage as discussed in the aforementioned paragraph, centering the post on the jack saddle can be extremely difficult in real-world lifting evolutions. Again, buckling of the lifting assembly leads to property damage, personal injury, or death.

From the above discussion, it may be understood that there are a few shortcomings involving the use of common lumber posts with typical hydraulic bottle jacks and other similar lifting devices. Towards this end, there exists a need to provide a device for temporarily centering and assisting in securing a post over a lifting device as well as protecting the post bottom via a rigid surface between the post and jack, therein making it more convenient and safer to use.

### SUMMARY

Various embodiments of the present disclosure provide a lifting device accessory.

In one aspect, an apparatus for protecting the temporarily adjoined post from a lifting devise is disclosed. The apparatus includes a rigid flat plate with an upper and lower surface. This flat plate provides protection by increasing the surface area of the hard surface of the lifting device to a greater area on the softer, wooden post. The upper surface of the flat plate has a rim affixed to the edge. The rim is sized to accommodate the end of a typical wooden lifting post. The lower surface of the flat plate has a circular pipe affixed. The circular pipe is adapted for centering a lifting device by the use of threaded holes on opposing ends to accommodate screws.

With the bottle jack or similar lifting device in place, the apparatus can be set onto the lifting devise. This is accomplished by inserting the saddle inside the circular pipe until the saddle is resting on the lower surface of the flat plate. The aforementioned screws are then tightened evenly as needed, making contact with the saddle and positioning the apparatus so it is centered over the lifting device saddle. The lifting device saddle is thereby centered within the circular pipe, and thus, centered under the flat plate. With the apparatus secured and centered over the saddle, the appropriately sized lifting post can then be set within the rim and upon the upper surface of the flat plate. With the fabricated dimension of the rim around the flat plate's upper surface sized slightly greater than the dimensions of the typically sized lifting post, the lifting post is thereby reasonably centered upon the flat plate's upper surface. This setup results in a lifting assembly whereby the lifting post is centered over the lifting saddle and is separated by a flat, rigid plate of metal, deterring the lifting assembly from buckling as well as deterring lower post surface deformation.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 is a front view of an apparatus for temporarily aligning and protecting the end surface of a post from a typical lifting device in accordance with an example embodiment of the present disclosure;

FIG. 2 is a top perspective view of an apparatus for temporarily aligning and protecting the end surface of a post from a typical lifting device in accordance with an example embodiment of the present disclosure;

FIG. 3 is a bottom perspective view of an apparatus for temporarily aligning and protecting the end surface of a post from a typical lifting device in accordance with an example embodiment of the present disclosure;

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

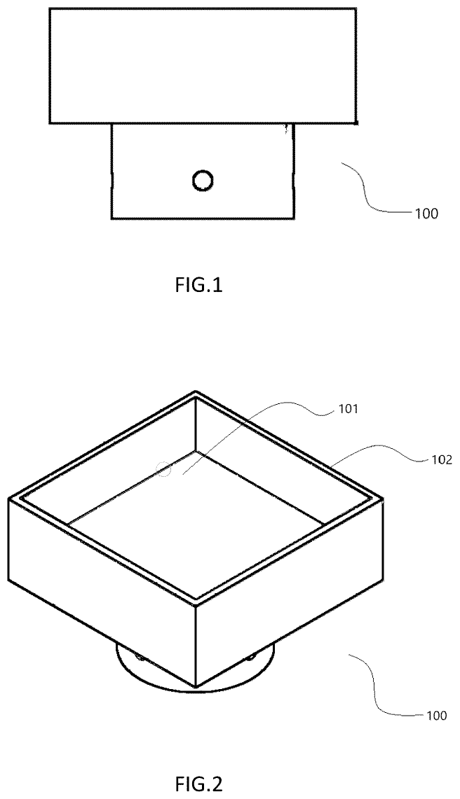

Referring to the drawings, FIG. 1 illustrates a frontal view of an apparatus (generally designated by the numeral 100) for an apparatus for temporarily aligning and protecting the end surface of a post from a typical lifting device. Hereinafter, the term “lifting apparatus 100” has been interchangeably used with the term “apparatus for temporarily aligning and protecting the end surface of a post from a typical lifting device,” without any limitations. In FIG. 1, the flat plate 101 is a flat, ridged material (typically carbon steel plate) whose calculated characteristics are thick enough and strong enough to withstand puncture or significant bending deformation resulting from the difference in stress area and hardness of the lifting post and lifting device on its upper and lower surfaces, respectively.

Referring to the drawings, FIG. 2 illustrates a perspective top view of lifting apparatus 100. In it, the rim 102 is shown fabricated and positioned on the outside upper surface of plate 101. It is of sufficient thickness and height to encompass the bottom of a typical, nominally sized piece of lumber commonly used as a lifting post. Its purpose is to prevent significant movement of the lifting post it surrounds.

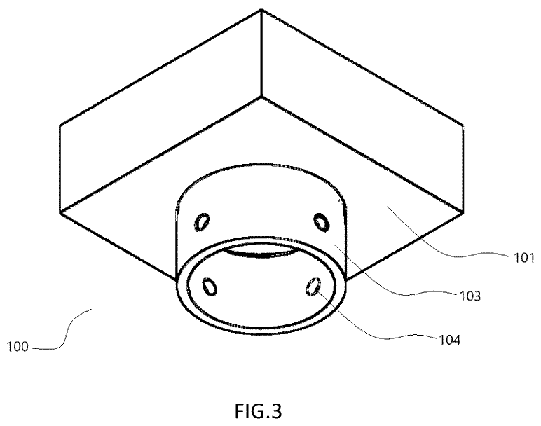

Referring to the drawings, FIG. 3 illustrates a perspective bottom view of lifting apparatus 100. In it, the cylindrical pipe 103 is shown centrally located and axially positioned on the lower surface of plate 101. It is of sufficient thickness and length to encompass the saddle (head) of a variety of commonly used lifting device (typically various sized hydraulic bottle jack).

As illustrated in FIG. 3, threaded holes 0104 are shown passing radially through cylindrical pipe 0103. The threaded holes are positioned on opposite sides of the cylindrical pipe, and of the same distance from the plate 101. This configuration allows for bolts to pass through cylindrical pipe 103. By turning bolts in (clockwise), the threaded ends of the bolts can press against the side of the saddle of the lifting device and locking it in position. A sufficient number of threaded holes can be positioned and associated bolts can be adjusted in and out to center the lifting apparatus 100 over the lifting device.

Embodiments of the present disclosure substantially eliminate or at least partially address the aforementioned problems in the background, and provide an improved lifting apparatus 100 for temporarily aligning and protecting the end surface of a lifting post from a typical lifting device. The lifting apparatus 100 of the present disclosure provides a safer and more convenient alternative to traditional methods used for lifting structures or equipment. While the conventional lifting techniques are inconvenient and potentially dangerous, the lifting apparatus 100 of the present disclosure allows both novice homeowners and professionals more confidence in lifting structures in a faster and safer manner.

A typical lifting evolution using the lifting apparatus 100 would follow as, the lifting apparatus 100 is set on top of an appropriately sized lifting device (typically a bottle jack), whereby the lower surface of the rigid flat plate 101 is in full contact with the saddle of the lifting device. Bolts are then tightened within the threaded holes 104 of the cylindrical pipe 103. Bolts are threaded equidistant into the cylindrical pipe 103 until firm contact is made with the side surface of the lifting device saddle. Lifting apparatus 100 should be reasonably centered and secured above the lifting device with no ability to shift. Next, a lifting post (typically a nominal 4 inch by 4 inch square piece of timber) is inserted onto the upper surface of plate 101 and within the rim 102. Given the predictable size of 4 inch nominal lumber posts, the rim was sized at fabrication of lifting apparatus 100 to reasonably center the lumber post. The lifting post is now centered on the lifting apparatus 100, which is thereby reasonably centered over the lifting device. A user can now use one hand to hold the post and the other hand to slowly pump the lifting device until contact is made, and the lifting assembly is secured. The user can now lift their equipment or structure with added assurance and safety that the bottom of the post has added protection from splitting, and the lifting assembly, being reasonably centered, has a reduced risk of buckling.

The embodiments illustrated and described herein as well as embodiments not specifically described herein but within the scope of aspects of the invention constitute exemplary temporarily aligning and protecting the end surface of a lifting post from a typical lifting device.

The benefits and advantages described above may relate to one embodiment or may relate to several embodiments. The embodiments are not limited to those that solve any or all of the stated problems or those that have any or all of the stated benefits and advantages.

The above description is given by way of example only and various modifications may be made by those skilled in the art. The above specification, examples, and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

What is claimed is:

1. An apparatus for temporarily aligning and protecting the end surface of a post in way of a typical lifting device in an adjacent relationship and comprising of a flat, rigid plate with an upper and lower surface.

2. The apparatus as claimed in claim 1, wherein the flat, rigid plate is capable of withstanding high pressures as to not puncture or significantly deform.

3. The apparatus as claimed in claim 1, wherein the flat, rigid plate's upper surface has a rim affixed and positioned along the edge, and whose dimensions are sized to allow for insertion and centering of common lumber typically used as lifting posts.

4. The apparatus as claimed in claim 1, wherein the flat, rigid plate's lower surface has a centrally located circular pipe affixed axially and whose pipe inside diameter allows for insertion of a hydraulic bottle jack saddle or similar lifting device.

5. The apparatus as claimed in claim 4, further comprising of a sufficient amount of threaded holes arranged in opposing, radial positions to accommodate bolts, wherein the bolts can be turned in and out to engage the sides of typical lifting device saddle, thereby allowing for the apparatus to be centered over a variety of different sized lifting devices.
